(19) United States
(12) Patent Application Publication
(10) Pub. No.: US 2025/0116859 A1
(43) Pub. Date: Apr. 10, 2025

(54) IMAGE GENERATING DEVICE AND HEAD-UP DISPLAY COMPRISING SUCH A DEVICE

(71) Applicant: VALEO COMFORT AND DRIVING ASSISTANCE, Créteil (FR)

(72) Inventors: Ayoub Ben Nachouane, Créteil (FR); Pierre Mermillod, Créteil (FR); Laurent Raddaz, Créteil (FR); Alexis Kleckner, Créteil (FR)

(73) Assignee: VALEO COMFORT AND DRIVING ASSISTANCE, Créteil (FR)

(21) Appl. No.: 18/293,469

(22) PCT Filed: Jul. 28, 2022
(86) PCT No.: PCT/EP2022/071286

§ 371 Date: Jan. 30, 2024

(30) Foreign Application Priority Data
Jul. 30, 2021 (FR) FR2108290

(51) Int. Cl. G02B 27/01; B60K 35/23; G02F 1/1333; G02F 1/1335; G02F 1/1368

(52) U.S. Cl. CPC G02B 27/0101; B60K 35/23; G02F 1/133385; G02F 1/133504; G02F 1/133553; G02F 1/1368; B60K 2360/23

(57) ABSTRACT

An image generating device is disclosed having a first light source configured to generate a first upstream light beam, a second light source configured to generate a second upstream light beam, and an array of variable transmittance elements configured to selectively receive and transmit the first upstream light beam and to selectively receive and transmit the second upstream light beam so as to form, respectively, a first downstream light beam forming a first image and a second downstream light beam forming a second image. A head-up display including an image generating device is also disclosed.

### TECHNICAL FIELD

The present invention relates to the technical field of display systems, notably to the technical field of image projection systems.

The invention more specifically relates to an image generating device, notably suitable for use in a head-up display of a motor vehicle.

### TECHNOLOGICAL BACKGROUND

In the above field, a head-up display is a device for displaying driving assistance information in the field of vision of the driver.

To this end, head-up displays comprise an image generating device, for example, a light source coupled to an array of variable transmittance elements, for example, a liquid crystal display (LCD), and an optical system for transmitting this image to a partially transparent strip, for example, so that the driver can see the images without looking away from the road. Some head-up displays comprise an array of variable transmittance elements that allow two images to be generated simultaneously, which images appear at different distances in the field of vision of the driver, for example. This is notably useful for augmented reality head-up displays.

The technologies for acquiring two images are complex and have a high production cost.

### SUMMARY OF THE INVENTION

An image generating device and a head-up display are proposed that overcome the aforementioned problems.

According to one aspect, an image generating device is proposed comprising a first light source configured to generate a first upstream light beam, a second light source configured to generate a second upstream light beam, and an array of variable transmittance elements configured to selectively receive and transmit the first upstream light beam and to selectively receive and transmit the second upstream light beam so as to respectively form a first downstream light beam forming a first image and a second downstream light beam forming a second image.

Within the meaning of the invention, the terms “upstream” and “downstream” refer to positions along the propagation path of the light emitted by the light source. Thus, the term “downstream” means closer to the light source and the term “upstream” means further from the light source, along the propagation path.

The invention allows two distinct images to be generated by simple and economical means. For example, in the case of a device fitted to a head-up display of a motor vehicle, the device according to the invention advantageously can be used to generate a first conventional image and a second augmented reality image. The driver then benefits from an improved driving assistance interface.

According to one embodiment, the array of variable transmittance elements is a thin film transistor liquid crystal display.

A liquid crystal display is a simple and inexpensive implementation of an array of variable transmittance elements.

According to one embodiment, a downstream face of the array of variable transmittance elements is in contact with an at least partially transparent plate configured to limit heating of the array of variable transmittance elements.

Limiting the heating of the array of variable transmittance elements advantageously allows its service life to be extended. Furthermore, installing a heat sink is particularly advantageous for discharging the heat generated by the light beams originating from the two light sources.

According to one embodiment, the device comprises a first heat sink thermally coupled with the partially transparent plate.

According to one embodiment, at least one of the first and second light sources is configured to transmit its upstream light beam to the array of variable transmittance elements through an optical diffuser, the device comprising a second heat sink configured to discharge the heat confined between the diffuser and the array of variable transmittance elements.

According to one embodiment, the second heat sink is in contact with the upstream face of the array of variable transmittance elements.

According to one embodiment, at least one heat sink is coupled to a forced convection cooling module.

According to one embodiment, the downstream face of the partially transparent plate is in contact with a cold face of a thermoelectric cooling module.

According to one embodiment, the first heat sink is in contact with a hot face of the thermoelectric cooling module.

According to one embodiment, the downstream face of the partially transparent plate is in contact with the first heat sink.

According to one embodiment, at least one of the first and second light sources is configured to transmit its upstream light beam to an optical diffuser through a reflector.

According to one embodiment, the direction of propagation of the first upstream beam and the direction of propagation of the second upstream beam form an angle ranging between 0° and 45°.

According to one embodiment, the first downstream beam is reflected onto a first concave mirror and the second downstream beam is reflected onto a second concave mirror, with the first concave mirror and the second concave mirror being fixed relative to each other and secured to the same support.

According to one embodiment, at least one of the first and second concave mirrors is a cold mirror.

The invention further relates to a head-up display comprising a device according to the aspect of the invention and one of the aforementioned embodiments and a system for projecting downstream beams toward a partially transparent strip.

Of course, the various features, alternative embodiments and embodiments of the invention can be associated with one another in various combinations insofar as they are not incompatible or mutually exclusive.

### BRIEF DESCRIPTION OF THE FIGURES

In addition, various other features of the invention will become apparent from the accompanying description that is provided with reference to the drawings, which illustrate non-limiting embodiments of the invention, and in which:

FIG. 1 schematically illustrates a head-up display comprising an image generating device according to one embodiment of the invention;

FIG. 2 is a schematic cross-sectional view of an image generating device according to the invention;

FIG. 3 is a schematic view of a folding mirror of a device according to the invention;

FIG. 4 is a schematic view of two other folding mirrors of a device according to the invention;

FIG. 5 is a profile view of the folding mirrors of FIG. 4;

FIG. 6 is a schematic cross-sectional view of an image generating device according to another embodiment of the invention;

FIG. 7 is a schematic cross-sectional view of an image generating device according to another embodiment of the invention;

FIG. 8 is a schematic cross-sectional view of an image generating device according to another embodiment of the invention.

It should be noted that throughout these figures the structural and/or functional elements common to the various alternative embodiments can have the same reference signs.

### DETAILED DESCRIPTION

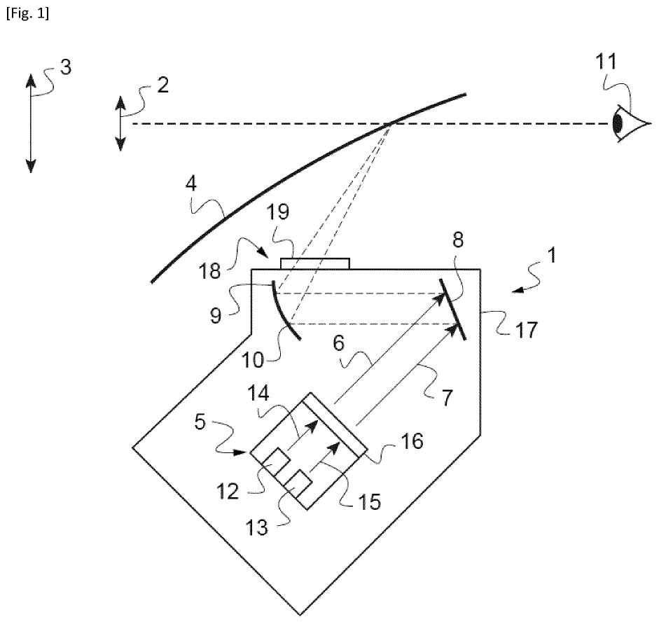

FIG. 1 schematically shows the main elements of a head-up display 1 intended, for example, to be fitted to a vehicle, notably a motor vehicle.

The display in FIG. 1 is adapted to create two virtual images 2 and 3 in the field of vision of a driver of the vehicle, so that the driver can see these virtual images 2, 3 and any information they contain without having to look away.

To this end, the display 1 comprises a partially transparent strip 4 placed in the field of vision of the driver, an image generating device 5 adapted to generate two downstream light beams 6 and 7 and a projection device 8, 9, 10 adapted to reflect, toward said partially transparent strip 4, the downstream light beams 6, 7 generated by the image generating device 5. In this case, the display 1 is configured so that the two virtual images 2, 3 appear at distinct respective distances. For example, the first virtual image 2 in this case is a conventional image and appears at a first distance from the driver, and the second virtual image is an augmented reality image that is integrated into the environment facing the vehicle and therefore appears at a second distance from the driver that is greater than the first distance.

The partially transparent strip 4 in this case is coincident with the windscreen of the vehicle. In other words, it is the windscreen of the vehicle that acts as a partially transparent strip for the head-up display 1. This configuration is particularly suitable for projecting augmented reality images.

As an alternative embodiment, the partially transparent strip could be a combiner, i.e., a partially transparent strip separate from the windscreen and intended for the head-up display. Such a combiner would be placed between the windscreen of the vehicle and the eyes 11 of the driver, in the path of the downstream light beams 6, 7.

The image projection device 5 in this case comprises three folding mirrors 8, 9, 10. A first folding mirror 8 and a second folding mirror 9 are arranged so as to reflect a first downstream light beam 5 generated by the image generating device 5 toward the partially transparent strip 3. The first folding mirror 8 and a third folding mirror 10 are arranged so as to reflect a second downstream light beam 7 generated by the image generating device 5 toward the partially transparent strip 3. The folding mirrors 8, 9 and 10 advantageously allow the image generating device 5 to be placed in a configuration in which it does not face the partially transparent strip 4 and therefore to be placed in any suitable location, typically under the vehicle dashboard.

For example, in this case, the first folding mirror 8 is a flat mirror and the second folding mirror 9 and the third folding mirror 10 are curved mirrors, in this case concave, which each assume a shape that is optimized for producing a virtual image assuming a shape adapted to the partially transparent strip 4, in this case a curved shape, so as to display the image in an undistorted manner. In addition, the second folding mirror 9 and the third folding mirror 10 have functions for enlarging the image generated by the array of variable transmittance elements.

According to other embodiments, the image generating device 5 could comprise a different number of mirrors and/or mirrors assuming different shapes, as well as other optical elements, for example, a lens.

The image generating device 5 comprises a first light source 12 and a second light source 13, in this case arrays of light-emitting diodes (LEDs), configured to produce a first upstream light beam 14 and a second upstream light beam 15, respectively. The image generating device 5 further comprises an array 16 of variable transmittance elements configured to be illuminated by the upstream light beams 14, 15.

The array 16 of variable transmittance elements is configured to selectively transmit the first upstream light beam 14 so as to form the first downstream light beam 6 representing a first image 2 to be projected into the field of vision of the driver by means of the partially transparent strip 4, and to selectively transmit the second upstream light beam 15 so as to form the second downstream light beam 7 representing a second image 3 to be projected into the field of vision of the driver by means of the partially transparent strip 4.

The head-up display 1 also comprises a casing 17 (generally opaque) that contains the image generating device 5 and the projection system 8, 9, 10, notably in order to protect these elements against any external attacks (dust, liquids, etc.).

The casing 17 comprises an opening 18, through which the downstream light beams 6, 7 pass, in this case after being reflected onto the folding mirrors 9 and 10.

The opening 18 in the casing 17 is closed by a window 19 (sometimes called “cover window”) made, for example, from a sheet of polycarbonate-type plastic with a thickness ranging between 0.25 mm and 0.75 mm.

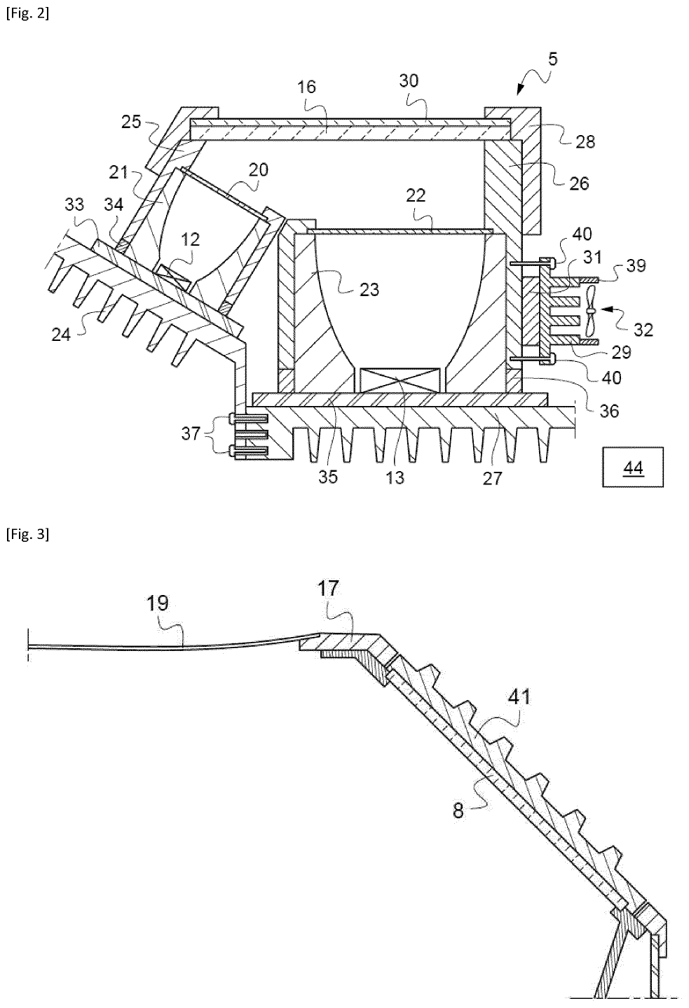

FIG. 2 is a schematic view showing the image generating device 5 in greater detail than in FIG. 1. In particular, FIG. 2 schematically shows a cross-section of a heat dissipation system of the image generating device 5.

In this embodiment, the first light source 12 is optically coupled to a first optical diffuser 20, and is fixed to the optical diffuser 20 by means of a first optical reflector 21. Similarly, the second light source 13 is optically coupled to a second optical diffuser 22 and is fixed to the second optical diffuser 22 by means of a second optical reflector 23.

The first light source 12 and the second light source 13 are oriented so that the direction of propagation of the first upstream light beam 14 and the direction of propagation of the second downstream light beam 15 form an angle ranging between 0° and 45°, for example, an angle greater than 0°, in this case an angle of 30°. In particular, in this case, the direction of propagation of the second upstream light beam 15 is orthogonal to the array 16 of variable transmittance elements.

The array 16 of variable transmittance elements in this case is a Thin Film Transistor Liquid Crystal Display (TFT-LCD), comprising an array of liquid crystal elements placed between two polarizers (an upstream polarizer, or input polarizer, and a downstream polarizer, or output polarizer, not shown) forming the upstream and downstream faces of the array 16 of variable transmittance elements. The array of variable transmittance elements in this case is controlled by control means 44.

In the embodiment shown in FIG. 2, the heat dissipation system comprises a plurality of passive heat sinks 24 to 29, a partially transparent dissipative plate 30, a thermoelectric cooling module 31, or Peltier module, as well as a forced convection cooling module 32.

The passive heat sinks 24 to 29 are configured to keep the operating temperature of the image generating device 5 below its functional thermal limits, in this case below a temperature of 110° C. Thus, the conductivity of the materials of each of the passive heat sinks 24 to 29 is greater than 20 W·m¹·K 1, and preferably greater than 60 W·m⁻¹·K⁻¹. For example, in this case, the passive heat sinks 25 to 29 are made of aluminum and have thermal conductivity of 220 W·m⁻¹·K⁻¹. The heat sinks can comprise any other material that allow the aforementioned heat dissipation requirements to be met, for example, aluminum alloys or magnesium alloys.

In order to improve heat dissipation and to effectively protect the passive heat sinks 25 to 29 against corrosion, the heat sinks 24 to 29 in this case are covered with an anodization layer.

The first light source 12 is secured to a first PCB-type electronic board 33, to which it is electrically connected. The electronic board 33 comprises, for example, a control circuit for the first light source 12, for example, controlled by the control means 44.

The rear face of the first electronic board 33, i.e., the face opposite the face to which the first light source 12 is fixed, is in contact with a first passive heat sink 24. The face of the first passive heat sink 24 that is directly in contact with the light source 8 is flat or substantially flat, and the opposite face is provided with fins that allow the surface area of the first passive heat sink 24 that is in contact with the air to be increased and therefore allow heat exchanges with the outside to be increased.

In order to improve the thermal coupling between the light source and the first passive heat sink 24, in particular if either of the contact faces between the first electronic board 33 and the first passive heat sink 24 is not perfectly flat and has, for example, differences in level that are greater than 0.1 mm, the coupling can be achieved by means of a thermal interface material, for example, thermal adhesive, thermal pads, a phase-change material, etc.

A first end of the first optical reflector 21 is fixed to the electronic board 33, for example, using screws and/or adhesive material, so as to surround the first light source 12, with the first optical diffuser 20 being fixed to a second end of the first reflector 21. Thus, all the light originating from the first light source 12, or at least a significant proportion of this light, is directed through the first optical diffuser 20.

The first optical reflector 21 is housed in a second passive heat sink 25, so that the first diffuser 20, and in particular a peripheral zone of the first diffuser 20, is clamped between the second end of the first reflector 21 and the second passive heat sink 25. The peripheral zone of the first diffuser 21 is not optically useful and in this case is delimited by a central, optically useful, zone through which the first upstream light beam 14 passes.

The second passive heat sink 25 in this case is fixed to the first electronic board 33 by means of a first thermally insulating support 34, so that the heat dissipated by the second passive heat sink 25 is not transmitted to the first electronic board 33.

A wall of the second passive heat sink 25 extends as far as the array 16 of variable transmittance elements, so as to be in contact with a peripheral zone of the array of variable transmittance elements, in the vicinity of its upstream face. The second passive heat sink 25 therefore helps to discharge the heat confined between the first diffuser 20 and the array 16 of variable transmittance elements.

As described above, the second light source 13 is fitted with a second optical reflector 23 fixed to a second electronic board 35 by means of a second thermally insulating support 36 and is configured to direct all the light originating from the second light source, or at least a significant proportion of this light, through the second optical diffuser 22. The second electronic board comprises, for example, a circuit for controlling the second light source 13, for example, controlled by the control means 44.

A wall of the third passive heat sink 26 extends as far as the array 16 of variable transmittance elements, so as to be in contact with a peripheral zone of the array 16 of variable transmittance elements, in the vicinity of its upstream face. The second passive heat sink 26 therefore helps to discharge the heat confined between the second diffuser 20 and the array 16 of variable transmittance elements.

The rear face of the second electronic board 35 is in contact with a fourth passive heat sink 27, in this case a finned heat sink. A thermal interface material in this case also can be used to improve the coupling between the second electronic board and the fourth heat sink 27. The first passive heat sink 24 and the fourth passive heat sink 27 are mutually secured by means of fixing means, in this case screws 37.

The downstream face of the array 16 of variable transmittance elements is in contact with a partially transparent plate 30. The partially transparent plate 30 in this case is configured to drain heat from the array 16 of variable transmittance elements. The upstream face of the partially transparent plate 30 in this case is in contact with the downstream face of the array 16 of variable transmittance elements. In particular, in this case, the partially transparent plate 30 has the same transverse dimensions as the array 16 of variable transmittance elements, and it completely covers said array. Thus, the partially transparent plate 30 is thermally coupled to the array 16 of variable transmittance elements.

The partially transparent plate 30 in this case is a ceramic plate and in this example has thermal conductivity of more than 5 W·m⁻¹·K⁻¹, and preferably of more than 10 W·m⁻¹·K⁻¹.

Preferably, the thickness of the partially transparent plate 21 is less than or equal to 1.1 mm, and even more preferably ranges between 0.5 mm and 0.9 mm, in this case 0.7 mm.

A fifth passive heat sink 28 in this case is in contact with the peripheral zone of the downstream face of the partially transparent plate 30, with the edge of the array 16 of variable transmittance elements and of the partially transparent plate 30 and with part of the external surfaces of the second and third heat sinks 25 and 26. In the configuration shown in FIG. 2, the partially transparent plate 30 and the array 16 of variable transmittance elements are clamped between the second and third heat sinks 25 and 26 (in the vicinity of the upstream face of the array 16 of variable transmittance elements) and the fifth passive heat sink 28 (in the vicinity of the downstream face of the partially transparent plate 16).

Thus, the second, third and fifth heat sinks 25, 26 and 28, as well as the partially transparent plate 30, help to discharge the heat received by the array 16 of variable transmittance elements.

It should be noted in this case that the peripheral zone of the array 16 of variable transmittance elements, respectively of the partially transparent plate 30, is not optically useful and delimits a central zone through which the upstream light beams 14, 15 pass, optionally selectively, so as to form the downstream light beams 6 and 7.

In order to further improve heat discharge, at least one of the passive heat sinks is thermally coupled to an active heat dissipation system.

The active heat dissipation system comprises the thermoelectric cooling module 31, or Peltier module, the cold face of which in this case is in contact with the external surface of the third passive heat sink 26, for example, by means of a thermal interface material, and the hot face of which is in contact with the forced convection cooling module 32.

Within the meaning of the invention, the cold face of a thermoelectric module is the face that is configured to be in contact with the element to be cooled, it therefore absorbs heat. The hot face is the opposite face, which discharges (or releases) the heat. Thus, in a thermoelectric module, heat circulates from the cold face to the hot face.

The thermoelectric module 31 in this case is configured so that the temperature difference between its cold face and its hot face is less than 10° C., and preferably equal to 0° C. A person skilled in the art will be able to find a compromise between the temperature difference and the power consumption of the thermoelectric module 22 depending on the applications they contemplate.

The forced convection cooling module 32 comprises a sixth passive heat sink 29, one face of which is coupled to the hot face of the thermoelectric module 31, and which has a plurality of fins on the side opposite the face in contact with the thermoelectric module.

The forced convection cooling module further comprises an axial flow fan 39 mechanically connected to the sixth heat sink 29, for example, in this case by screws 40. For example, in this case, the size of the fan 39 ranges between 25 mm×25 mm and 60 mm×60 mm, and it is configured so that its speed of rotation is less than or equal to 400 revolutions per minute. The fan 39 also can be configured to have a noise level that is less than or equal to 25 dB.

The thermoelectric cooling module 31 and the forced convection cooling module 32 are controlled by the control means 44.

FIG. 3 illustrates a heat dissipation system for the first folding mirror 8. In this case, the first folding mirror is a flat mirror. For example, the first folding mirror 8 is configured to act as a dichroic filter and, in particular in this case, the first folding mirror 8 is configured to transmit all the infrared radiation of the unpolarized visible part of the solar radiation arriving on its surface, in order to reflect the polarized visible part of the solar radiation, and to reflect all the light originating from the first and second light sources. In other words, the first folding mirror 8 is a cold mirror.

Such a mirror in this case is obtained by applying a filtering coating onto the reflective face of the mirror, for example, a CMF (Cold Mirror Film) adhesive film.

The rear face of the first folding mirror 8, i.e., the face opposite the reflective face to which the CMF film is applied in this case, is in contact with a seventh heat sink 41, for example, by means of a thermal interface material.

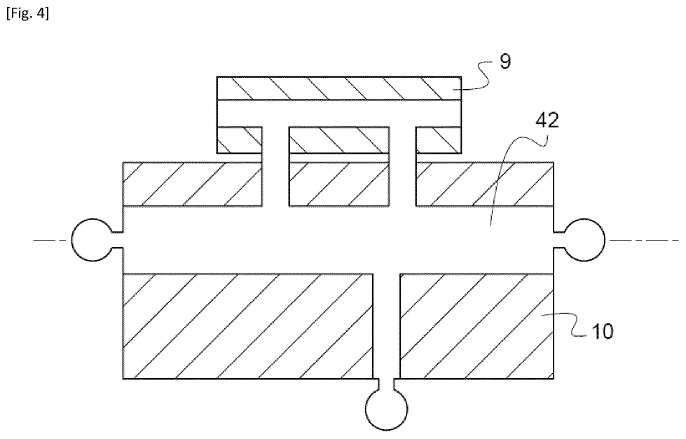

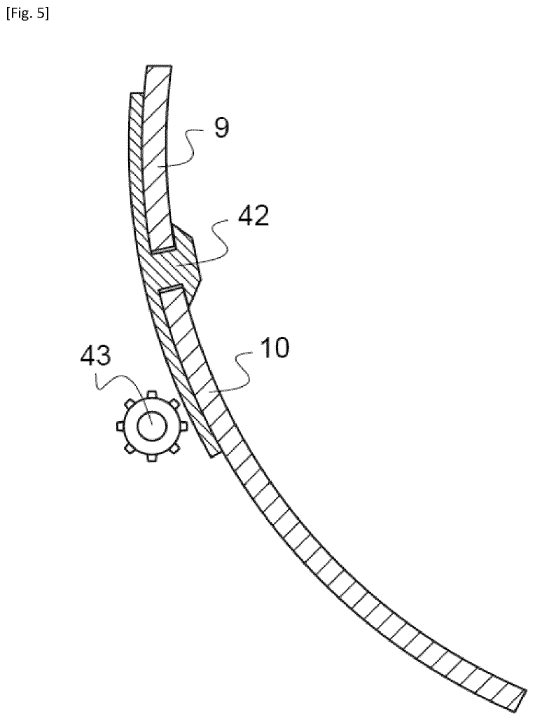

The second and third folding mirrors 9 and 10 are illustrated in FIG. 4, which is a rear view of these two mirrors, and in FIG. 5, which is a profile view of these two mirrors. In this case, the second and third folding mirrors 9 and 10 are concave mirrors, for example, in this case each covered with a CMF-type adhesive film. The second folding mirror 9 and the third folding mirror 10 are secured to the same support 42 coupled to a mechanical transmission system 43 configured to adjust the position of the support 42. The mechanical transmission system 43 is controlled by the control means 44.

The second folding mirror 9 and the third folding mirror in this case have the same radius of curvature and are fixed to the support 42 so that their respective centers of curvature coincide. The dimensions of the first folding mirror 9 are suitable for projecting standard images and the dimensions of the second folding mirror are suitable for projecting augmented reality images. The dimensions of the second folding mirror 10 are larger than those of the first folding mirror 9.

The forced convection cooling module 32 and the thermoelectric cooling module 31 are controlled in conjunction with real-time temperature measurement in order to adapt the speed of rotation of the fan 39 and the nominal temperature difference between the cold face and the hot face of the thermoelectric cooling module 31. This advantageously allows the power consumption of the active cooling system to be optimized, for example, by limiting the number of situations during which the active cooling system is used.

The temperature is measured, for example, using a temperature sensor or a plurality of sensors distributed over various points on the image generating device 5.

For example,
a temperature sensor is installed in the structure of the array of variable transmittance elements, and/or an infrared sensor is pointed at the array 16 of variable transmittance elements and is configured to locate the zones of the array with a maximum temperature;
the electronic boards 33 and 35 comprise temperature sensors configured to measure the temperature of the electronic boards and/or the light sources;
a sensor placed in the casing 17 is configured to measure the ambient temperature inside the casing 17;
a temperature sensor installed in the thermoelectric cooling module 31 allows the temperature of the cold face to be measured.

According to other embodiments, only some of these sensors can be present.

In order to optimize the cooling and the power consumption of the image generating device 5, the control means 44 are configured to operate according to an operating mode that is selected from three operating modes.

According to a first operating mode, the control means are configured to keep the temperature difference between the cold face and the hot face of the thermoelectric cooling module at a predetermined value, independently of the thermal load imposed on the image generating device 5. According to this first operating mode, the control means 44 are configured to adapt the speed of the fan 39 of the forced convection cooling module, notably as a function of the values fedback by the temperature sensors and of the desired temperature of the image generating device 5.

According to a second operating mode, the control means 44 are configured to keep the speed of rotation of the fan 39 constant and to adapt the temperature difference between the cold face and the hot face of the thermoelectric cooling module 31, notably as a function of the values fedback by the temperature sensors and of the desired temperature of the image generating device 5.

According to a third operating mode, the control means 44 are configured to adapt both the temperature difference between the hot face and the cold face of the thermoelectric cooling module 31, and the speed of rotation of the fan 39, notably as a function of the values fedback by the temperature sensors and of the desired temperature of the image generating device 5.

According to other embodiments, reflective polarizers can be coupled to the first optical diffuser 20, to the second optical diffuser 21 and/or to the array 16 of variable transmittance elements.

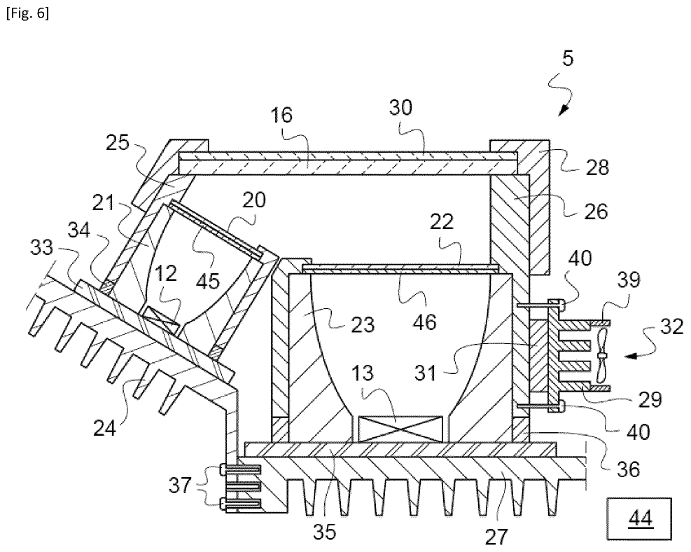

For example, FIG. 6 illustrates an embodiment in which a first reflective polarizer 45 covers the downstream face of the first optical diffuser 21 and a second reflective polarizer 46 covers the downstream face of the second optical diffuser 22.

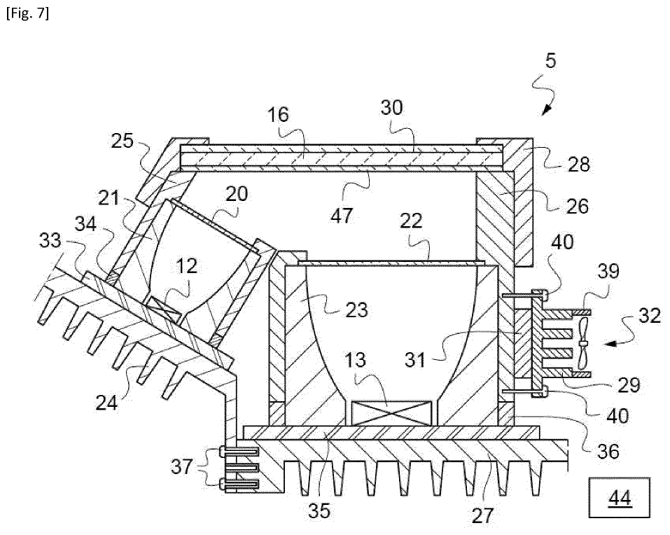

FIG. 7 illustrates an embodiment in which a third reflective polarizer covers the upstream face of the array 16 of variable transmittance elements.

Reflective polarizers allow light with a determined direction of polarization to be transmitted and allow light without this determined direction of polarization to be reflected. In this case, the determined direction of polarization is a direction parallel to the polarization of the input (or upstream) polarizer of the array of variable transmittance elements. Thus, the proportion of light rays absorbed by the array of variable transmittance elements is reduced, thereby limiting the heating thereof.

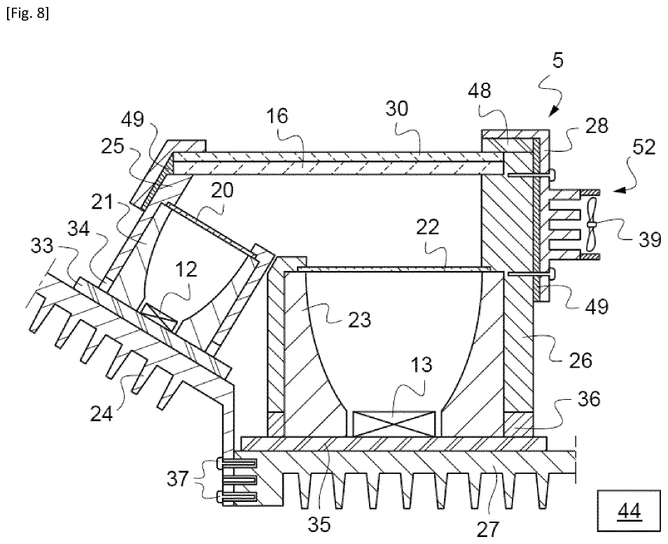

According to another embodiment of the invention, a thermoelectric cooling module is thermally coupled to the array 16 of variable transmittance elements. For example, as illustrated in FIG. 8, a second thermoelectric cooling module 48 is placed between the partially transparent plate 30 and the fifth passive heat sink 28. In this case, the cold face of the second thermoelectric cooling module 48 is in contact with the peripheral zone of the partially transparent plate 30, and its hot face is in contact with the fifth passive heat sink 28.

In the embodiment illustrated in FIG. 7, the second thermoelectric cooling module 48 is, for example, rectangular and extends along an edge of the partially transparent plate 30. According to other embodiments, the thermoelectric cooling module extends along several edges of the partially transparent plate 30. In particular, according to some embodiments, the thermoelectric cooling module could be in the shape of a frame.

In this case, the fifth passive heat sink 28 comprises a portion of its external surface that is provided with fins. This finned portion in this case is coupled to the forced convection cooling module 32.

Moreover, in this embodiment, the fifth passive heat sink 28 is thermally insulated from the passive heat sinks 25 and 26 by thermal insulation parts 49. Thus, the heat discharged from the screen is not redirected toward these heat sinks 25 and 26. Cooling the array 16 of variable transmittance elements therefore does not interfere with cooling of the inside of the casing.

Various other modifications can be made to the invention within the scope of the appended claims.

1. An image generating device comprising:
a first light source configured to generate a first upstream light beam,
a second light source configured to generate a second upstream light beam, and
an array of variable transmittance elements configured to selectively receive and transmit the first upstream light beam and to selectively receive and transmit the second upstream light beam so as to respectively form a first downstream light beam forming a first image and a second downstream light beam forming a second image.

2. The device as claimed in claim 1,
wherein the array of variable transmittance elements is a thin film transistor liquid crystal display.

3. The device as claimed in claim 1,
wherein a downstream face of the array of variable transmittance elements is in contact with an at least partially transparent plate configured to limit heating of the array of variable transmittance elements.

4. The device as claimed in claim 1,
further comprising a first heat sink thermally coupled with the partially transparent plate.

5. The device as claimed in claim 1,
wherein at least one of the first and second light sources is configured to transmit its upstream light beam to the array of variable transmittance elements through an optical diffuser,
wherein the device further comprises a second heat sink configured to discharge the heat confined between the diffuser and the array of variable transmittance elements.

6. The device as claimed in claim 1,
wherein the second heat sink is in contact with the upstream face of the array of variable transmittance elements.

7. The device as claimed in claim 1,
wherein at least one heat sink is coupled to a forced convection cooling module.

8. The device as claimed in claim 4,
wherein the downstream face of the partially transparent plate is in contact with a cold face of a thermoelectric cooling module.

9. The device as claimed in claim 8,
wherein the first heat sink is in contact with a hot face of the thermoelectric module.

10. The device as claimed in claim 1,
wherein the downstream face of the partially transparent plate is in contact with the first heat sink.

11. The device as claimed in claim 1,
wherein at least one of the first and second light sources is configured to transmit its upstream light beam to an optical diffuser through a reflector.

12. The device as claimed in claim 1,
wherein the direction of propagation of the first upstream light beam and the direction of propagation of the second upstream light beam form an angle ranging between 0° and 45°.

13. The device as claimed in claim 1,
wherein the first downstream light beam is reflected onto a first concave mirror and the second downstream beam is reflected onto a second concave mirror,
wherein the first concave mirror and the second concave mirror are fixed relative to each other and secured to the same support.

14. The device as claimed in claim 13,
wherein at least one of the first and second mirrors is a cold mirror.

15. A head-up display comprising: a device as claimed in claim 1; and a system for projecting downstream light beams toward a partially transparent strip.
